(19) United States
(12) Patent Application Publication
(10) Pub. No.: US 2009/0000124 A1
(43) Pub. Date: Jan. 1, 2009

(54) GROOMING TOOL ASSEMBLY

(75) Inventors: Gregg A. Micinilio, Trumbull, CT (US); Andrew J. Pennella, Stamford, CT (US); Mark Peyser, Easton, CT (US); Philipp Pfenniger, Triengen (CH)

Correspondence Address: Michaud-Duffy Group LLP, 306 Industrial Park Road, Suite 206, Middletown, CT, 06457, US

(73) Assignee: EVEREADY BATTERY COMPANY, INC., St. Louis, MO (US)

(21) Appl. No.: 12/140,344

(22) Filed: Jun. 17, 2008

Related U.S. Application Data
(60) Provisional application No. 60/937,842, filed on Jun. 29, 2007.

(51) Int. Cl. B26B 19/00; B26B 19/28; B26B 21/00

(52) U.S. Cl. 30/34.1; 30/45; 30/526

(57) ABSTRACT

A battery powered grooming tool is provided that includes a safety razor assembly adjoined to a hair trimmer assembly. Both assemblies include a housing. The housings may be separable or may be integrally formed. The trimmer assembly includes a motor operably connected to a moving toothed blade. The motor has a diameter less than 18 mm, a peak efficiency greater than 55% and an output torque greater than 0.8 mNm at peak efficiency. The grooming tool has a width less than 25 mm and a mass less than 80 g and the grooming tool is ergonomically familiar to a typical safety razor user.

### CROSS REFERENCE TO RELATED APPLICATIONS

This application claims the benefit of U.S. Provisional Patent Application Ser. No. 60/937,842, filed Jun. 29, 2007.

### BACKGROUND

1. Technical Field

This application relates generally to grooming devices, and more specifically to safety razors that include a motorized hair trimmer.

2. Background Information

Many safety razors include an elongated hand gripping portion that is ergonomically sized to be comfortably gripped by a user. The gripping portion can be generally straight or include a slight curve. Many of these safety razors have an elongated gripping portion that can be enclosed by a cylinder and/or a portion of a torus both having a diameter in the range from about 10 mm to about 25 mm.

In U.S. Patent application publication 2005/0217115, the disclosure of which is incorporated herein for reference in its entirety, a safety razor handle is provided that includes a battery-powered motor-driven hair trimmer. Many trimmers, including the devices disclosed in the aforementioned application include a toothed blade that moves to and for relative to a second toothed blade. A spring provides a force to this moving blade to maintain at least the toothed portions of both blades in sliding contact with each other during normal use to ensure efficient hair trimming.

Upon actuation of a switch or other initiating device to start a motorized trimmer of the aforementioned type, the torque requirements of the motor can be momentarily relatively high compared to the torque requirements for continuous running. When the motorized trimmer is started, static friction of the system has to be overcome. One major contributor of static friction is the contact of the moving blade to the second blade under the force provided by the spring.

In contrast, in another type of razor, a razor handle can be provided with a battery powered motor having an eccentric weight that can provide and transmit vibration to the razor cartridge for improved shaving closeness or comfort during use. Such devices are disclosed in several publications including U.S. Pat. No. 5,299,354 to Metcalf et al. The motor torque requirements for a so-called vibrating or oscillating razor similar to the device of the '354 patent at start-up are relatively low. Major contributors of static friction of a vibrating razor system include motor bearing static friction which is inherently low.

In general, motors having a relatively high torque are larger in terms of dimensions and mass than motors having a relatively low torque. Furthermore, motors having a relatively high torque generally have higher energy consumption.

### SUMMARY

The present invention has for its objective to eliminate, or at least substantially alleviate the limitations of the prior art by providing a battery powered grooming tool that includes a motorized trimmer attachable or integral with a safety razor that has a similar size and a similar heft to many safety razors so that it is ergonomically familiar to a safety razor user. It is further desirous to provide a battery life for such a tool that is perceived by a user to be satisfactory.

In one aspect the present application is directed to a battery powered trimmer assembly. The trimmer assembly comprises a trimmer housing having a motor disposed within the trimmer housing. A moving blade is operatively connected to the motor. The peak efficiency of the motor is greater than 55%, preferably about 68%, and the output torque is greater than 0.8 mNm (milliNewton meter), preferably about 0.98 mNm, at peak efficiency. The motor has a diameter less than 18 mm, preferably about 15.5 mm and the housing has a width less than 25 mm. The trimmer assembly is adapted to be mounted to a safety razor. The trimmer assembly in combination with the safety razor has a combined mass less than 80 g. The trimmer assembly in combination with the safety razor has a size and a heft that are ergonomically familiar to a safety razor user. The battery life is perceived by a user to be satisfactory.

In a further aspect, the present application is directed to a grooming tool. The grooming tool has a housing having a safety razor cartridge support assembly at a first end and a trimmer drive assembly at the opposed end. The trimmer drive assembly has a motor and a moving blade operatively connected to the motor. The peak efficiency of the motor is greater than 55%, preferably about 68%, and the output torque is greater than 0.8 mNm, preferably about 0.98 mNm, at peak efficiency. The motor has a diameter less than 18 mm, preferably about 15.5 mm and the housing has a width less than 25 mm. The grooming tool has a mass less than 80 g. The grooming tool has a size and a heft that are ergonomically familiar to a safety razor user. The battery life is perceived by a user to be satisfactory.

The above features and advantages of the present application will be more fully understood with reference to the following detailed description when taken in conjunction with the accompanying drawings.

### BRIEF DESCRIPTION OF THE DRAWINGS

FIG. 1 is an isometric view of an embodiment of a trimmer assembly of the present application in combination with a safety razor assembly.

FIG. 2 is an isometric view of an embodiment of a grooming tool of the present application.

FIG. 3 is a sectional view on lines 3-3 of FIG. 1.

FIG. 3A is an enlarged view of a portion of FIG. 3.

FIGS. 4-6 are respectively orthogonal end, top and side views of a motor of the present application.

### DETAILED DESCRIPTION

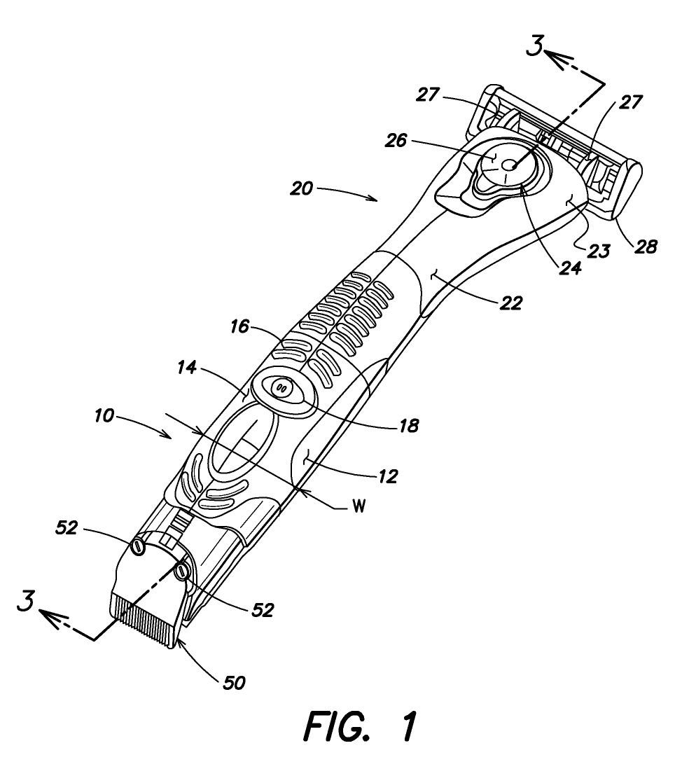

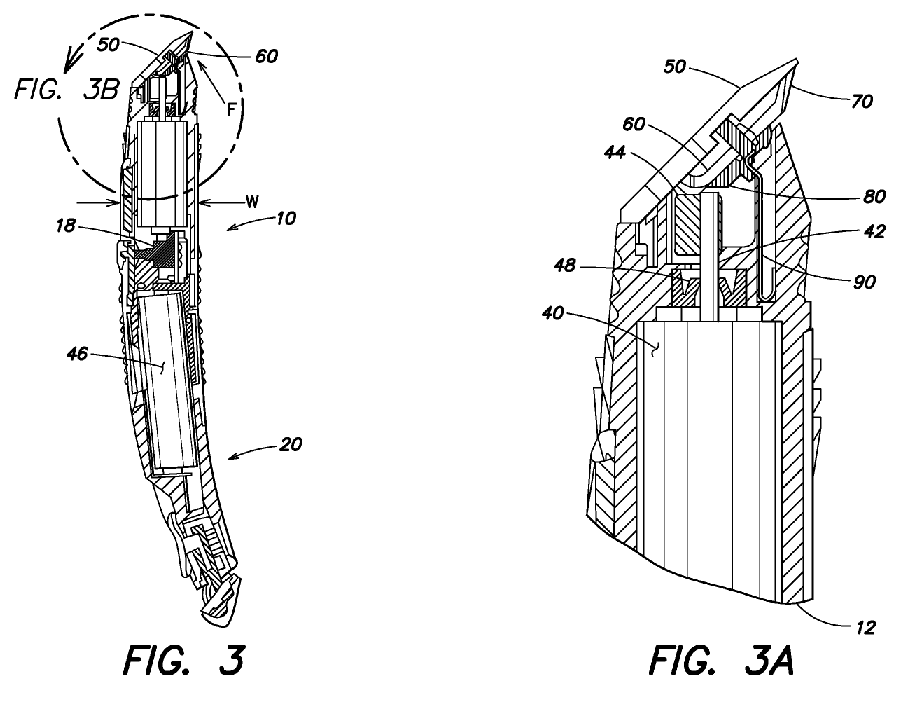

Referring now to the drawings and in particular FIG. 1, a battery powered trimmer assembly 10 is shown mounted to a safety razor assembly 20. The trimmer assembly is preferably mounted to the safety razor assembly with a well-known bayonet type arrangement. The trimmer assembly includes an elongated housing 12. The housing has a width W (see also FIG. 3) defined as the side-to-side dimension of the housing in a direction transverse to the direction of elongation of the housing. Width W is defined independently of the orientation of the trimmer assembly (see also FIG. 3). The width excludes any raised ribs 16 that may be added to enhance the real or perceived grip of the housing by a user. The width is preferably less than 25 mm, more preferably less than 23 mm and most preferably less than 20 mm. In this manner the trimmer housing will not be ergonomically unfamiliar to a user of a safety razor.

The trimmer assembly also preferably includes a switch assembly 18 provided to initiate operation of the trimmer when selectively actuated by a user. The present application is not limited in regard to the operation initiating means employed and this can also be automatic in that it does not require a specific physical action by the user. The initiating means can include a moisture sensor that initiates operation when the trimmer assembly comes into contact with water. A typical moisture sensor is described in US Patent Application publication 2006/0032053 where it is used to initiate a vibration mechanism, essential subject matter of which is incorporated herein for reference. The initiating means can also include a proximity sensor that initiates operation when the trimmer assembly is brought into close proximity to the skin of the user. A typical proximity sensor is described in US Patent Application publication 2006/0032055 where it is used to initiate a vibration mechanism, essential subject matter of which is incorporated herein for reference. The sensor can also include a Hall effect sensor or magnetic switch or tilt switch that initiates operation when the device is removed from a storage tray (not shown). A typical magnet switch is described in US Patent Application publication 2006/0032054 where it is used to initiate a vibration mechanism, essential subject matter of which is incorporated herein for reference. The sensor can also include a motion sensor or accelerometer that initiates operation when the trimmer assembly is not stationary and in use. Termination of operation of the trimmer assembly can be accomplished by negation of any sensor signal, as described above. In other embodiments of the present application, a controller (not shown) may also be provided in electrical communication with the battery, motor and initiating means. Termination of operation can be achieved by the controller, for example after a predetermined time. GB Patent application 2,417,007, essential subject matter of which is incorporated herein for reference, discloses a safety razor having a fluid delivery system. The fluid delivery system includes a control device for actuating a pump and deactivating the pump after a certain time of actuation, e.g. 0.1 to 2 seconds.

The safety razor assembly also includes an elongated housing 22; a razor cartridge support assembly 24 that includes a user operable cartridge release button 26 and cartridge support arms 27 adapted to receive a razor cartridge 28. The safety razor assembly housing has a width as previously described but can include a locally widened portion 23 that can house part of the cartridge support assembly. Suitable support assemblies and razor cartridges are well known in the art and will not be discussed further in the present application. One or both housings of the trimmer assembly and safety razor assembly can also include resilient gripping pads 14.

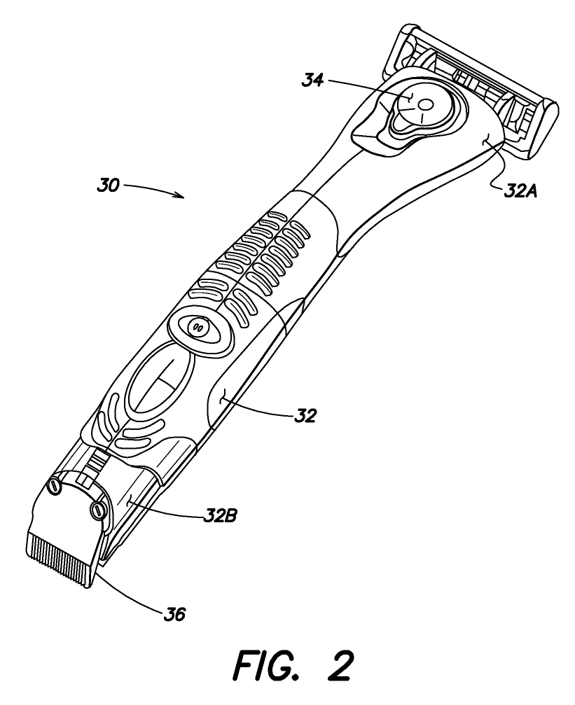

Referring now to FIG. 2 a battery powered grooming tool 30 is depicted. The grooming tool includes an elongated housing 32. The housing has a width as previously described and may include a locally widened portion also as previously described. The housing 32 has a safety razor cartridge support assembly 34 disposed at a first end 32A of the housing and a trimmer drive assembly 36 disposed at the opposed end 32B of the housing. The trimmer drive assembly 36 can also be disposed at the same end of the housing as the safety razor cartridge support assembly 34 as for example is disclosed in embodiments of U.S. Patent application publication 2005/0217115, the disclosure of which is incorporated herein for reference in its entirety.

Referring additionally now to FIGS. 3 and 3A, the trimmer assembly of FIG. 1 is shown in sectional view (FIG. 3) and enlarged scale partial sectional view (FIG. 3A). The trimmer assembly 10 includes a housing 12. The housing is preferably manufactured by injection molding ABS or polypropylene or die-cast zinc alloy or other suitable material well known to one of skill in the art. Disposed at least partially within the housing is a motor 40, powered by one or more batteries 46. In order to provide a housing having a width ergonomically familiar to a safety razor user the battery is preferably a single AAA battery, however the present application is not limited in this regard and other battery combinations may be suitably employed such as single AA battery, one or more AAAA batteries or so-called prismatic batteries. The batteries can be disposable or rechargeable.

Mounted on the output shaft 42 of the motor is an eccentric 44. The eccentric provides to and for movement in a well known manner to a moving blade or moving blade assembly, described later in the present application. A lower blade 50, having a toothed arrangement is mounted to the housing preferably by screws 52. A moving blade 60 including a toothed arrangement is operatively connected to the motor via the eccentric. The moving blade preferably includes a cutter part 70 and a driver part 80 but can also be a single part. The lower blade 50 and cutter 70 are both preferably made from 420 grade stainless steel hardened to 48-52 HRC. One of skill in the art will understand that other materials such as alternate grades of steel or stainless steel may equally be employed as well as ceramic materials and the present application is not limited in this regard. The driver is preferably manufactured by injection molding a suitable thermoplastic, preferably a so-called engineering grade material and most preferably polyamide 6,6. This material is selected for desirous properties including dimensional stability and its frictional characteristics when the eccentric moves in contact with the driver (described later in the present application) and when the driver moves in contact with the leaf spring (also described later in the present application) during normal use. One of skill in the art will understand alternate thermoplastic materials such as polyoxymethylene can also be employed or metallic materials such as phosphor bronze or zinc aluminum alloys.

As a safety razor can typically be used in a wet environment, certain seals are provided to prevent the ingress of water that may affect the function of the electrical parts of the trimmer assembly, i.e. the motor. Seals include a shaft seal 48 on the motor shaft.

A spring 90 is provided to apply a spring force to maintain at least the toothed portions of the lower and moving blades in sliding contact during normal use to ensure efficient hair cutting by the trimmer blades. The spring force preferably has a component of its force in a direction normal to a contact plane of the toothed portions of the moving and lower blades, F, in the range 2N to 6.5N and most preferably about 3N. The spring is preferably a leaf spring and is described in concurrently filed U.S. Patent application Ser. No. 60/937,762 having assignee's docket number 6579-0731 the disclosure of which is incorporated herein for reference in its entirety.

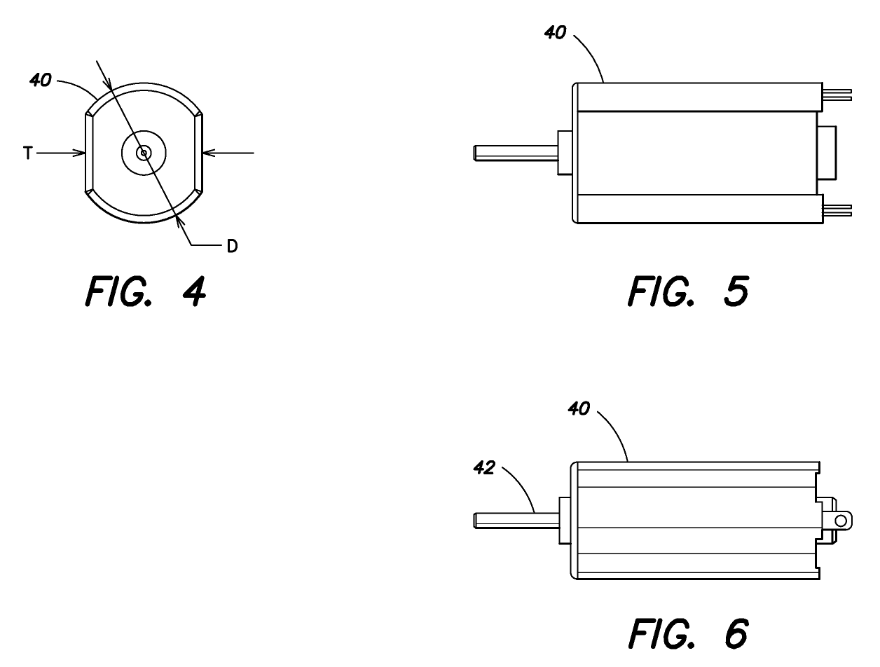

Upon actuation of the switch or other initiating means, the torque requirements of the motor 40 can be momentarily relatively high compared to the torque requirements for continuous running. When the trimmer assembly is started, static friction of the system has to be overcome. Major contributors of static friction include the shaft seal 48 and the contact of the moving blade to the second blade under the aforementioned force provided by the spring. The energy requirements of the motor can be momentarily high to provide the aforementioned torque and the motor starting current can exceed 2 to 3 Amps, whereas the continuous running current is preferably less than about 700 mA. This energy is provided by the battery and the high starting current can prematurely diminish the life of the battery. Moreover, the starting current can cause an apparent loss of battery life, that is, while the energy capacity of the battery can be capable of providing 700 mA it cannot provide 2-3 A and thus while the device is hypothetically capable of running it will not start. For a motor sized to be accommodated in the aforementioned housing and to provide a satisfactory torque with a consequential satisfactory battery life when used in preferred combination with a single alkaline AAA battery, the following parameters are preferred. Referring now to FIGS. 4-6, the motor has a diameter D less than 18 mm and most preferably about 15.5 mm. The motor can also have a thickness T across flats of about 12 mm and a mass less than 23 g and most preferably about 16-17 g. The peak efficiency is greater than 55% and most preferably about 68%. The output torque at peak efficiency is preferably greater than 0.8 mNm (milliNewton meters) and most preferably about 0.98 mNm. The stall torque is preferably greater than 4.4 mNm and most preferably about 5.0 to 5.6 mNm. The motor is preferably configured to have a greater torque in one direction of rotation than in the reverse direction. An accelerated simulated use test is used to evaluate battery life for a device incorporating the aforementioned motor and battery combination. Battery life for device powered by a single AAA battery is preferably greater than 13 weeks and most preferably greater than 20 weeks in a test simulating one use per week at 3 minutes per use.

One object of the present application is to provide a grooming tool or a trimmer assembly in combination with a safety razor having a width and heft that are ergonomically familiar to a safety razor user. Another object of the present application is to provide a battery life perceived by a user to be satisfactory. The grooming tool or trimmer assembly in combination with a safety razor of the present application has a width less than 25 mm, a mass less than 80 g and a battery life in an accelerated simulated use test greater than 13 weeks.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. For instance, features disclosed in connection with any one embodiment can be used alone or in combination with each feature of the respective other embodiments.

What we claim is:

1. A battery powered trimmer assembly, comprising:
a trimmer housing defining a width less than 25 mm;
a motor disposed within the trimmer housing; and
a moving blade operatively connected to the motor;
wherein the motor has: a diameter less than 18 mm; a peak efficiency greater than 55% and an output torque greater than 0.8 mNm at peak efficiency; and wherein the trimmer assembly is adapted to be mounted to a safety razor.

2. The trimmer assembly of claim 1, wherein the assembly further comprises a lower blade and a spring adapted to provide a normal force to the moving blade to maintain at least a toothed portion of the moving blade in sliding contact with a toothed portion of the lower blade during normal use.

3. The trimmer assembly of claim 2, wherein the normal force is between 2N and 6.5N.

4. The trimmer assembly of claim 3, wherein the normal force is about 3N.

5. The trimmer assembly of claim 1, wherein the assembly is removably mounted to the safety razor.

6. The trimmer assembly of claim 1, wherein the trimmer housing is integrally formed with a housing of the safety razor.

7. The trimmer assembly of claim 5 or claim 6, wherein the trimmer assembly in combination with the safety razor have a combined mass less than 80 g.

8. The trimmer assembly of claim 1, wherein the motor has a diameter about 15.5 mm; a peak efficiency about 68% and an output torque about 0.98 mNm at peak efficiency.

9. A grooming tool, comprising:
a housing;
a safety razor cartridge support assembly disposed at a first end of the housing;
a battery powered trimmer drive assembly disposed at an opposed end of the housing, comprising:
a motor;
a moving blade operatively connected to the motor,
wherein the motor has: a diameter less than 18 mm; a peak efficiency greater than 55% and an output torque greater than 0.8 mNm at peak efficiency.

10. The grooming tool of claim 9, wherein the housing defines a width less than 25 mm.

11. The grooming tool of claim 9, wherein the trimmer drive assembly further comprises a lower blade and a spring adapted to provide a normal force to the moving blade to maintain at least a toothed portion of the moving blade in sliding contact with a toothed portion of the lower blade during normal use.

12. The grooming tool of claim 11, wherein the normal force is between 2N and 6.5N.

13. The grooming tool of claim 12, wherein the normal force is about 3N.

14. The grooming tool of claim 9, wherein the grooming tool has a mass less than 80 g.

15. The grooming tool of claim 9, wherein the motor has a diameter about 15.5 mm; a peak efficiency about 68% and an output torque about 0.98 mNm at peak efficiency.
